(19) United States
(12) Patent Application Publication
(10) Pub. No.: US 2014/0232667 A1
(43) Pub. Date: Aug. 21, 2014

(54) ELECTRONIC DEVICE AND METHOD

(71) Applicant: Kabushiki Kaisha Toshiba, Tokyo (JP)

(72) Inventor: Qi Zhang, Nishitama-gun (JP)

(73) Assignee: Kabushiki Kaisha Toshiba, Tokyo (JP)

(21) Appl. No.: 13/966,014

(22) Filed: Aug. 13, 2013

Related U.S. Application Data
(63) Continuation of application No. PCT/JP2013/058422, filed on Mar. 22, 2013.

(30) Foreign Application Priority Data
Feb. 15, 2013 (JP) 2013-028415

(51) Int. Cl. G06F 3/0488

(52) U.S. Cl. CPC G06F 3/04883
USPC 345/173

(57) ABSTRACT

According to one embodiment, an electronic device includes an input terminal and a display controller. First stroke data corresponding to a plurality of strokes described by handwriting and second stroke data corresponding to a plurality of second strokes described by handwriting are input to the input terminal. The display controller executes control to display an n-number (n: an integer of 2 or more) of first lines at first intervals determined in accordance with a first area including the plurality of first strokes and a second area including the plurality of second strokes.

### CROSS-REFERENCE TO RELATED APPLICATIONS

This application is a Continuation Application of PCT Application No. PCT/JP2013/058422, filed Mar. 22, 2013 and based upon and claiming the benefit of priority from Japanese Patent Application No. 2013-028415, filed Feb. 15, 2013, the entire contents of all of which are incorporated herein by reference.

### FIELD

Embodiments described herein relate generally to a handwritten document.

### BACKGROUND

In recent years, various kinds of electronic devices, such as a tablet, a PDA and a smartphone, have been developed. Most of these electronic devices include touch-screen displays for facilitating input operations by users.

By touching a menu or an object, which is displayed on the touch-screen display, by a finger or the like, the user can instruct a portable electronic device to execute a function which is associated with the menu or object.

However, most of existing electronic devices with touch-screen displays are not necessarily suitable for use in a business situation such as a meeting, a business negotiation or product development. Thus, in business situations, paper-based pocket notebooks have still been widely used.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view illustrating an external appearance of an electronic device according to an embodiment.

FIG. 2 is a view illustrating an example of a cooperative operation between the electronic device of the embodiment and an external apparatus.

FIG. 3 is a view illustrating an example of a handwritten document which is handwritten on the electronic device of the embodiment.

FIG. 4 is a view illustrating an example of time-series information which is stored in the electronic device of the embodiment.

FIG. 5 is a block diagram illustrating a configuration example of the electronic device of the embodiment.

FIG. 6 is a block diagram illustrating a functional configuration example of a digital notebook application program according to an embodiment.

FIG. 7 is a view illustrating an example of a result of a block-structuring process in the embodiment.

FIG. 8 is a view illustrating an example of a process result of setting an interval of ruled lines in the embodiment.

### DETAILED DESCRIPTION

Various embodiments will be described hereinafter with reference to the accompanying drawings.

In general, according to one embodiment, an electronic device comprises an input terminal and a display controller. First stroke data corresponding to a plurality of strokes described by handwriting and second stroke data corresponding to a plurality of second strokes described by handwriting are input to the input terminal. The display controller executes control to display an n-number (n: an integer of 2 or more) of first lines at first intervals determined in accordance with a first area including the plurality of first strokes and a second area including the plurality of second strokes.

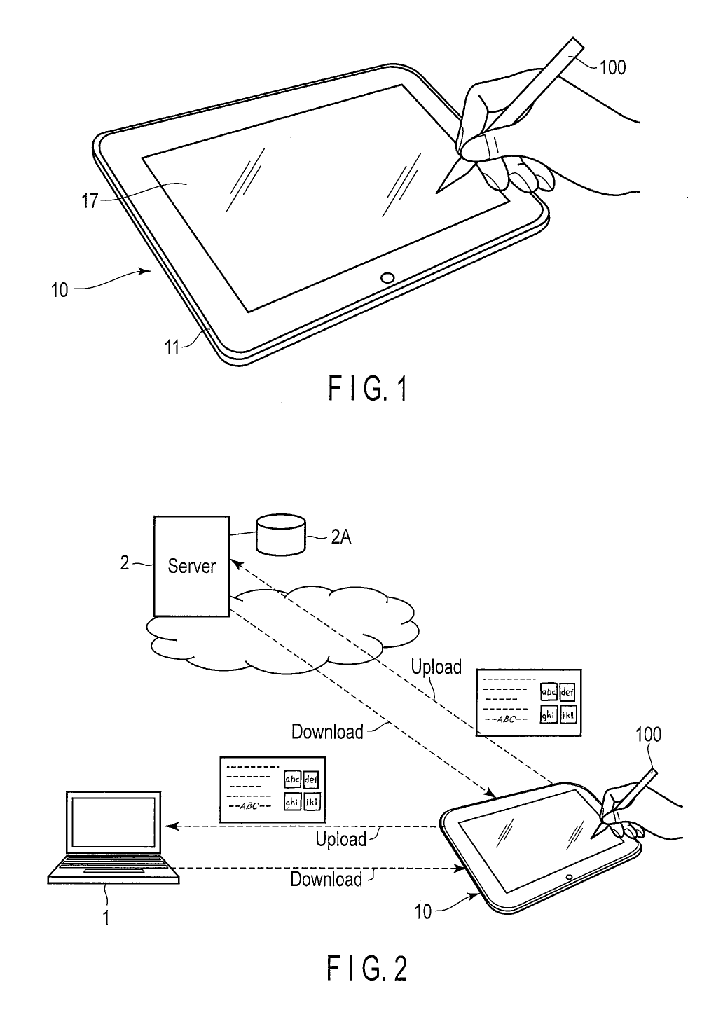

FIG. 1 is a perspective view illustrating an external appearance of an electronic device according to an embodiment. The electronic device can execute a handwriting input, for example, by a pen or a finger. This electronic device is a tablet, a notebook-type personal computer, a smartphone, a PDA, a whiteboard-substitute large-sized display, etc. In the description below, the case is assumed that this electronic device is a tablet 10. The tablet 10 is an electronic device which is also called “tablet computer” or “slate computer”. The tablet 10 includes a main body 11 and a touch-screen display 17. The touch-screen display 17 is attached such that the touch-screen display 17 is laid over the top surface of the main body 11.

The main body 11 has a thin box-shaped housing. The touch-screen display 17 may be of any type if it functions both as a display capable of displaying electronic data in color or in black and white, and as an input device capable of detecting a position of contact on the screen (surface) by a pen or a finger. The touch-screen display 17 includes, for example, a flat-panel display and a sensor which detects a touch position of a pen or a finger on the screen of the flat-panel display. The flat-panel display may be, for instance, a liquid crystal display (LCD) or an organic EL display. As the sensor, for example, use may be made of an electrostatic capacitance-type touch panel, or an electromagnetic induction-type digitizer. In the description below, the case is assumed that two kinds of sensors, namely a digitizer and a touch panel, are both assembled in the touch-screen display 17. The digitizer and touch panel are provided in a manner to cover the screen of the flat-panel display.

The touch-screen display 17 can detect not only a touch operation on the screen with use of a finger, but also a touch operation on the screen with use of a pen 100. The pen 100 may be, for instance, an electromagnetic-induction pen. The user can input characters, graphics, etc. by handwriting on the touch-screen display 17 by using an external object (pen 100 or finger). A stroke may be any kind of locus (handwriting) described by handwriting, and is, for example, a locus (handwriting) which is input on the touch-screen display 17 by the external object, or a locus (handwriting) which is input by handwriting by other user interfaces. For example, a locus of movement of the external object during a time, from when the external object is once put in contact with the screen to when the external object is released from the screen, corresponds to one stroke. The touch-screen display 17 displays a locus of movement of the external object on the screen, that is, a handwritten stroke, on the screen in real time.

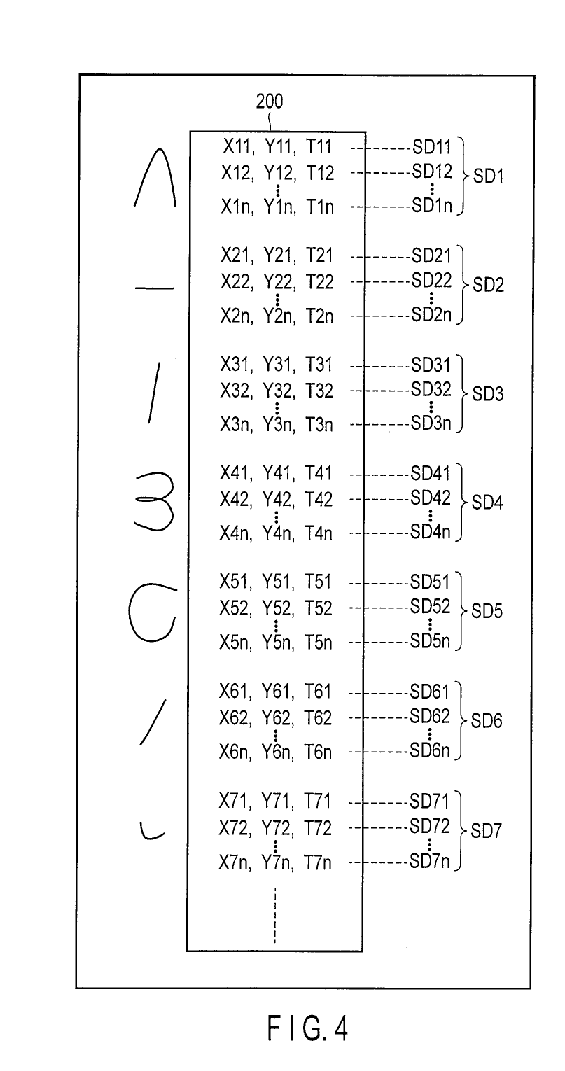

Electronic data (hereinafter referred to as “handwritten document”) of a handwritten document is a set of information pieces of many strokes corresponding to handwritten characters or graphics. The handwritten document is stored in a recording medium included in the tablet 10, another electronic device possessed by the user, a server, or a cloud. In the present embodiment, the handwritten document is stored in a storage medium not as image data but as time-series information indicative of coordinate series of each stroke (locus) and an order relation between strokes. The time-series information may be any kind of such data (hereinafter referred to as “stoke data”) that the order (stroke order), in which a plurality of strokes were handwritten, is discriminable, and each stroke (locus) can be specified. The details of the time-series information will be described later with reference to FIG. 4. One stroke data corresponds to a certain (single) stroke, and includes coordinate data corresponding to points on the locus of this stroke. The order of arrangement of stroke data included in time-series information may indicate an order in which strokes were handwritten, that is, an order of strokes. The time-series information may further include information of an order (order of strokes) in which strokes corresponding to stroke data were handwritten, and may further include a time point at which the stroke corresponding to each stroke data was handwritten. The description below is given of an example in which the handwritten document is stored as time-series information, but the handwritten document may be stored in such a format that the order (order of strokes) in which a plurality of strokes were handwritten is not discriminable.

The tablet 10 can display a plurality of strokes, which are indicated by time-series information, on the screen. The tablet 10 has an edit function. The edit function may include a function of deleting or moving an arbitrary stroke or an arbitrary handwritten character or the like in the displayed handwritten document, in accordance with an operation by the user with use of an “eraser” tool, a range select tool, and other various tools, and may include a function of clearing the history of some handwriting operations.

The time-series information (handwritten document) may be managed as one page or plural pages. The time-series information (handwritten document) may be divided in units of an area (page) which falls within one screen. The size of one page may be made variable. Since the size of a page can be increased to an area which is larger than the size of one screen, a handwritten document of an area larger than the size of the screen can be handled as one page. When one whole page cannot be displayed on the display at a time, this page may be reduced in size and displayed, or a display target part in the page may be moved by vertical and horizontal scroll.

FIG. 2 illustrates an example of a cooperative operation between the tablet 10 and an external apparatus. The tablet 10 can cooperate with a personal computer 1 or a cloud. The tablet 10 includes a communication device such as a wired LAN, a wireless LAN, or a cellular communication device (3G, LTE, LTE-advanced), and can communicate with the personal computer 1 or a server 2. The server 2 may be a server which executes an online storage service, and other various cloud computing services.

The personal computer 1 includes a storage device such as a hard disk drive (HDD), a semiconductor memory (NAND memory, NOR memory), etc. The tablet 10 can transmit time-series information (handwritten document) to the personal computer 1 over a network, and can store the time-series information in the storage device of the personal computer 1 (“upload”). In order to ensure a secure communication between the tablet 10 and personal computer 1, an authentication process may be executed between the personal computer 1 and the tablet 10 at a time of starting the communication. Thereby, even when the capacity of the storage in the tablet 10 is small, the tablet 10 can handle many time-series information items (handwritten documents) or large-volume time-series information (handwritten document). The tablet 10 can read out (“download”) one or more arbitrary time-series information items stored in the storage device of the personal computer 1, and can display each stroke indicated by the read-out time-series information on the screen of the display 17.

The destination of communication of the tablet 10 may be the server 2 on the cloud which provides storage services, etc. The tablet 10 can transmit time-series information (handwritten document) to the server 2 over the network, and can store the time-series information (handwritten document) in a storage device 2A of the server 2 (“upload”). Besides, the tablet 10 can read out arbitrary time-series information which is stored in the storage device 2A of the server 2 (“download”) and can display the locus of each stroke, which is indicated by this time-series information, on the screen of the display 17 of the tablet 10.

As has been described above, in the present embodiment, the storage medium in which the time-series information (handwritten document) is stored may be any storage device if it is accessible from the tablet 10, and may be the storage device in the tablet 10, the storage device in the personal computer 1, or the storage device in the server 2.

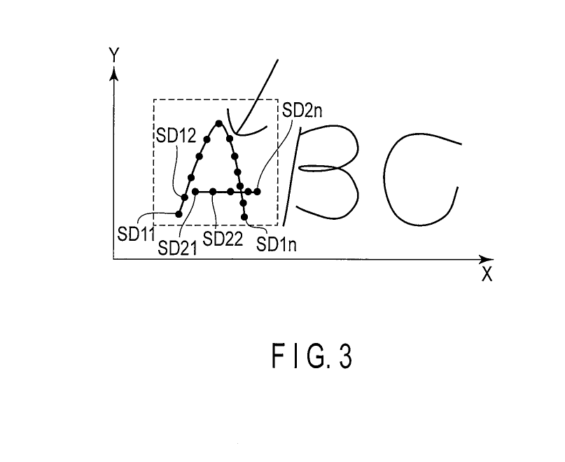

Next, referring to FIG. 3 and FIG. 4, a description is given of a relationship between strokes (characters, graphics, tables, etc.), which are handwritten by the user, and time-series information. FIG. 3 shows an example of a handwritten document which is handwritten on the touch-screen display 17 by using the pen 100 or the like. In a handwritten document, other characters or graphics may be handwritten over once handwritten characters or graphics. In FIG. 3, the case is assumed that a handwritten character string “ABC” was input in the order of “A”, “B” and “C”, and thereafter an “arrow” was handwritten near the handwritten character “A”.

FIG. 4 illustrates time-series information 200 corresponding to the handwritten document of FIG. 3. The time-series information 200 includes a plurality of stroke data SD1, SD2, . . . , SD7. In the example of the time-series information 200 shown in FIG. 4, the stroke data SD1, SD2, . . . , SD7 are arranged in an order of writing of strokes (time-series order).

The handwritten character “A” is expressed by two strokes (a locus of “ [symbol] ” shape, a locus of “-” shape) which are handwritten by using the pen 100 or the like, that is, by two loci. The locus of the pen 100 of the first handwritten “ [symbol] ” shape is sampled in real time, for example, at regular time intervals, and thereby the stroke data SD1 (time-series coordinates SD11, SD12, . . . , SD1n) of the “ [symbol] ” shape are obtained. Similarly, the locus of the pen 100 of the next handwritten “-” shape is sampled in real time, and thereby the stroke data SD2 (time-series coordinates SD21, SD22, . . . , SD2n) of the “-” shape are obtained. The handwritten character “B” is expressed by two stroke data SD3 and SD4 (time-series coordinates SD31, . . . , SD3n, SD41, . . . SD4n). The handwritten character “C” is expressed by one stroke data SD5 (time-series coordinates SD51, . . . , SD5n). The handwritten “arrow” is expressed by two stroke data SD6 and SD7 (time-series coordinates SD61, . . . , SD6n, SD71, . . . SD7n).

Each stroke data includes coordinate data series (time-series coordinates) corresponding to one stroke, that is, a plurality of coordinates corresponding to a plurality of points on the locus of one stroke. For example, as regards handwritten character “A”, the stroke data SD1 includes coordinate data series (time-series coordinates) corresponding to the points on the locus of the stroke of the handwritten “ [symbol] ” shape of the handwritten character “A”, that is, an n-number of coordinate data SD11, SD12, . . . , SD1n. The stroke data SD2 includes coordinate data series corresponding to the points on the locus of the stroke of the handwritten “-” shape of the handwritten character “A”, that is, an n-number of coordinate data SD21, SD22, . . . , SD2n. Incidentally, the number (n) of coordinate data may differ between respective stroke data.

Each coordinate data is indicative of an X coordinate and a Y coordinate, which correspond to one point in the associated locus. For example, the coordinate data SD11 is indicative of an X coordinate (X11) and a Y coordinate (Y11) of the starting point of the stroke of the “ [symbol] ” shape. SD1n is indicative of an X coordinate (X1n) and a Y coordinate (Yin) of the end point of the stroke of the “ [symbol] ” shape.

Further, each coordinate data may include time stamp information T corresponding to a time point at which a point corresponding to the coordinates of this coordinate data was handwritten. The time point at which the point was handwritten may be either an absolute time (e.g. year/month/day/hour/minute/second) or a relative time with reference to a certain time point. For example, an absolute time (e.g. year/month/day/hour/minute/second) at which a stroke began to be handwritten may be added as time stamp information to each stroke data, and furthermore a relative time indicative of a difference from the absolute time may be added as time stamp information T to each coordinate data in the stroke data. By each coordinate data (time-series information) including the time stamp information T, the temporal relation between strokes can be more precisely expressed.

Moreover, each coordinate data may include information (Z) indicative of a pen stroke pressure. Each coordinate data (time-series information) including the information (Z) indicative of a pen stroke pressure can precisely represent personal features with respect to strokes which are input by handwriting, and can precisely identify the person who input each stroke by handwriting.

With the use of the order of strokes (order of handwriting), even if a distal end portion of the handwritten “arrow” is written over the handwritten character “A” or near the handwritten character “A”, as shown in FIG. 3, the handwritten character “A” and the distal end portion of the handwritten “arrow” can be discriminated as different characters or graphics.

For example, the CPU of the tablet 10 can determine, from the time-series information 200, that the two strokes (stroke data SD1 and SD2) of the handwritten character “A” were successively handwritten, and that the handwriting timing of the distal end portion (stroke data SD7) of the handwritten “arrow” is later than the handwritten characters “B” and “C” and is not successive to the handwriting timing of the handwritten character “A”. Thereby, the CPU of the tablet 10 can discriminate the two strokes of the handwritten character “A” and the distal end portion of the handwritten “arrow” as different characters or graphics.

In addition, for example, with use of the above-described time stamp information T, the CPU of the tablet 10 can determine, when a difference between the time point of handwriting of the strokes corresponding to the stroke data SD1 and SD2 and the time point of handwriting of the stroke corresponding to the stroke data SD7 is a threshold or more, that the handwriting timing of the stroke data SD7 is not successive to the handwriting timing of the stroke data SD1 and SD2, and that these stroke data are different characters or graphics.

The case is now assumed that strokes included in an area surrounded by a broken line are designated by the user, as shown in FIG. 3. The range (designated range) surrounded by the broken line includes two strokes of the handwritten character “A” and one stroke corresponding to the distal end portion of the handwritten “arrow”. In this case, since the CPU of the tablet 10 can discriminate the two strokes (stoke data SD1 and SD2) of the handwritten character “A” and the distal end portion (stroke data SD7) of the handwritten “arrow” as being separate, the CPU of the tablet 10 can display an interface which enables the user to select either of them.

In the time-series information 200, the arrangement of stroke data SD1, SD2, . . . , SD7 indicates the order of strokes of handwritten characters. For example, the arrangement of stroke data SD1 and SD2 indicates that the stroke of the “ [symbol] ” shape was first handwritten and then the stroke of the “-” shape was handwritten. Thus, even when the traces of writing of two handwritten characters are similar to each other, if the orders of strokes of the two handwritten characters are different from each other, these two handwritten characters can be distinguished as different characters.

Since the handwritten document is stored as the time-series information 200 which is composed of a set of time-series stroke data, handwritten characters can be handled without depending on languages of the handwritten characters, and can be commonly used in various countries of the world where different languages are used.

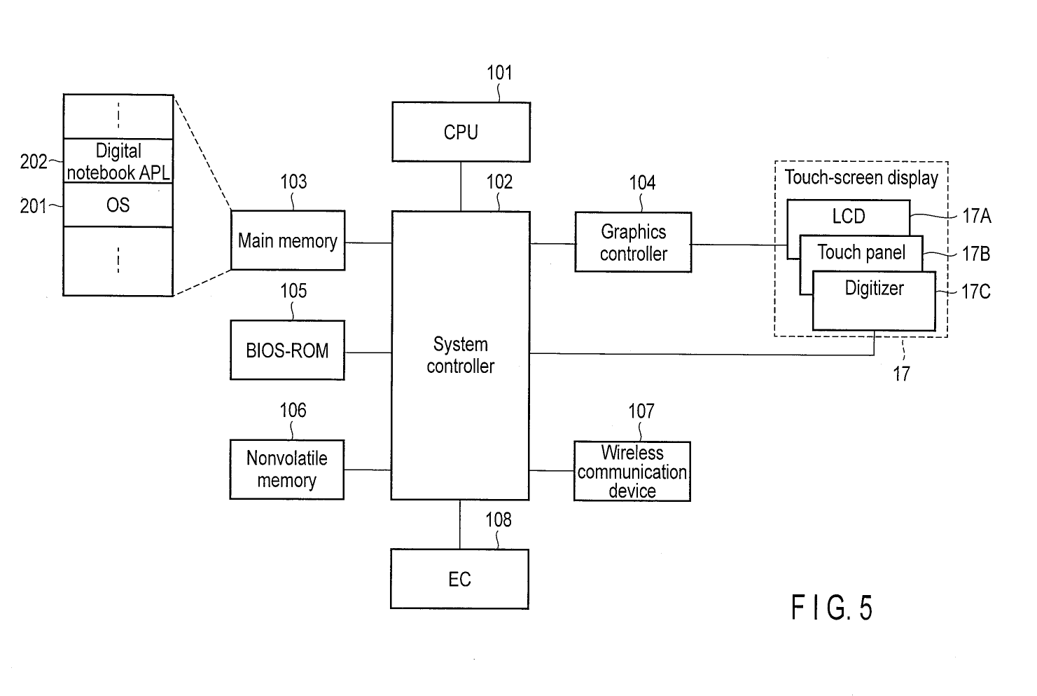

FIG. 5 is a view illustrating an example of the system configuration of the tablet 10. As shown in FIG. 5, the tablet 10 includes a CPU 101, a system controller 102, a main memory 103, a graphics controller 104, a BIOS-ROM 105, a nonvolatile memory 106, a wireless communication device 107, and an embedded controller (EC) 108.

The CPU 101 is a processor which controls the operations of various modules in the tablet 10. The CPU 101 executes various kinds of software, which are loaded from the nonvolatile memory 106 that is a storage device into the main memory 103. The software includes an operating system (OS) 201 and various application programs. The application programs include a digital notebook application program 202. The digital notebook application program 202 includes a function of creating and displaying the above-described handwritten document, a function of editing the handwritten document, a handwriting retrieve function, and a character/graphic recognition function. The CPU 101 also executes a basic input/output system (BIOS) which is stored in the BIOS-ROM 105. The BIOS is a program for hardware control.

The system controller 102 is a device which connects a local bus of the CPU 101 and various components. The system controller 102 includes a memory controller which access-controls the main memory 103. In addition, the system controller 102 includes a function of communicating with the graphics controller 104 via, e.g. a PCI EXPRESS serial bus.

The graphics controller 104 is a display controller which controls an LCD 17A that is used as a display monitor of the tablet computer 10. A display signal, which is generated by the graphics controller 104, is sent to the LCD 17A. The LCD 17A displays a screen image based on the display signal. A touch panel 17B and a digitizer 17C are disposed on the LCD 17A. The touch panel 17B is an electrostatic capacitance-type pointing device for executing an input on the screen of the LCD 17A. A contact position on the screen, which is touched by a finger, and a movement of the contact position, are detected by the touch panel 17B. The digitizer 17C is an electromagnetic induction-type pointing device for executing an input on the screen of the LCD 17A. A contact position on the screen, which is touched by the pen 100, and a movement of the contact position, are detected by the digitizer 17C.

The wireless communication device 107 is a device which executes wireless communication such as wireless LAN or cellular communication. The EC 108 is a one-chip microcomputer including an embedded controller for power management. The EC 108 includes a function of power on or power off the tablet computer 10 in accordance with an operation of a power button by the user.

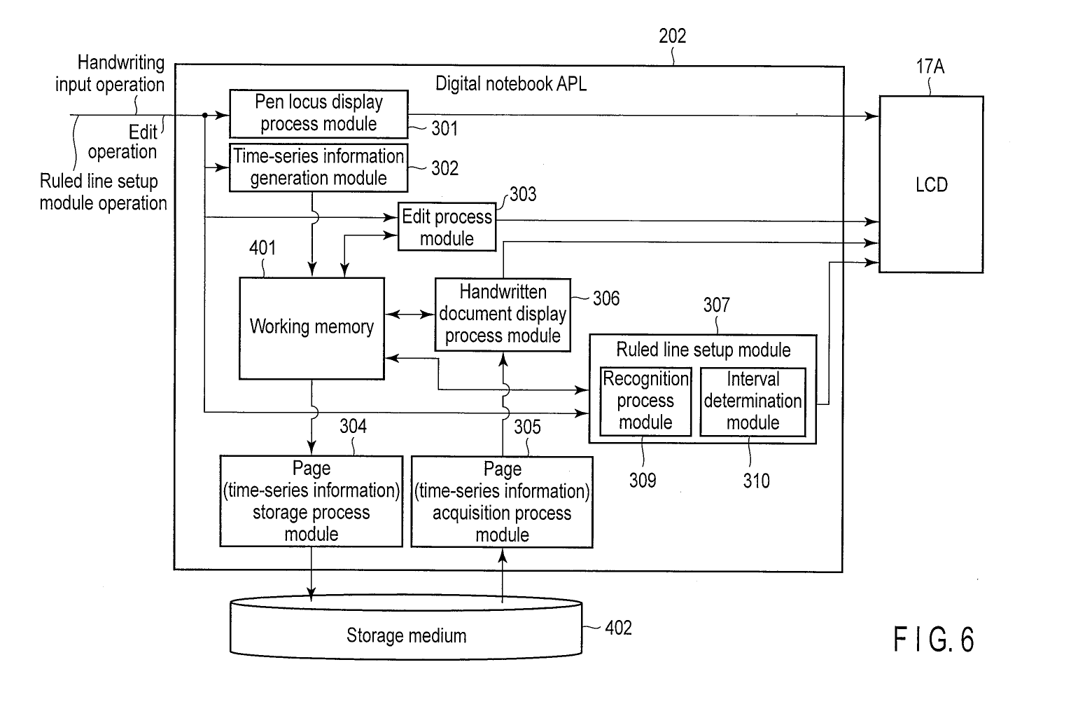

Next, referring to FIG. 6, a description is given of a functional configuration of the digital notebook application program 202. The digital notebook application program 202 includes a pen locus display process module 301, a time-series information generation module 302, an edit process module 303, a page storage process module 304, a page acquisition process module 305, a handwritten document display process module 306, and a ruled line setup module 307 (a recognition process module 309, an interval determination module 310). These functional blocks are executed by the CPU 101 which executes the digital notebook application program 202.

The digital notebook application program 202 executes creation, display and edit of a handwritten document by using event information, etc., which is input through the touch-screen display 17. The touch-screen display 17 detects the occurrence of events such as “touch”, “move (slide)” and “release”. The “touch” is an event indicating that an external object has come in contact with the screen. The “move (slide)” is an event indicating that the position of contact of the external object has been moved while the external object is in contact with the screen. The “release” is an event indicating that the external object has been released from the screen.

The pen locus display process module 301 and time-series information generation module 302 receive an event “touch” or “move (slide)” which is generated by the touch-screen display 17, thereby detecting a handwriting input operation. The “touch” event includes coordinates of a contact position. The “move (slide)” event includes coordinates of a contact position at an origin of movement, a contact position during movement, and a contact position at a destination of movement. The pen locus display process module 301 and time-series information generation module 302 receive coordinate series, which correspond to the locus of movement of the contact position, from the touch-screen display 17.

Based on the coordinate series received from the touch-screen display 17, the pen locus display process module 301 displays the locus of each stroke on the screen of the LCD 17A in the touch-screen display 17. The pen locus display process module 301 displays the locus of the pen 100 during a time in which the pen 100 is in contact with the screen, that is, the locus of each stroke.

Based on the coordinate series received from the touch-screen display 17, the time-series information generation module 302 generates the above-described time-series information having the structure as described in detail with reference to FIG. 4. The time-series information generation module 302 may temporarily store in a working memory 401 the time-series information, that is, the coordinates and time stamp information corresponding to the respective points of each stroke.

The page storage process module 304 stores the generated time-series information as a handwritten document (handwritten page) in a storage medium 402. The storage medium 402, as described above, may be any one of the storage device in the tablet 10, the storage device in the personal computer 1 and the storage device in the server 2.

The page acquisition process module 305 reads out from the storage medium 402 arbitrary time-series information which is stored in the storage medium 402, and sends the read-out time-series information to the handwritten document display process module 306. Based on the time-series information, the handwritten document display process module 306 displays the locus of each stroke on the screen as a handwritten page.

The edit process module 303 executes a process for editing a handwritten page which is currently being displayed. In accordance with an edit operation which is executed by the user on the touch-screen display 17, the edit process module 303 executes an edit process for deleting or moving one or more strokes of a plurality of stokes which are being displayed. For example, when a menu such as “delete” or “move” has been selected from the edit menu by the user, the edit process module 303 executes a process of delete, move, etc. on a stroke. For example, by using an “eraser” tool, an opposite-side end portion of the pen 100, or a tap by the pen 100, the user can delete an arbitrary stroke of the plural strokes which are being displayed. The user can move an arbitrary stroke of the plural strokes which are being displayed, by dragging and dropping the stroke by means of the external object. The edit process module 303 updates the time-series information which is being displayed, in order to reflect the result of the edit process on the time-series information. In the time-series information, the time-series coordinates of each moved stroke data may automatically be changed in accordance with a destination position of movement. An operation history, which indicates that the time-series coordinates of each moved stroke data have been changed, may be added to the time-series information. Each deleted stroke data may not necessarily be deleted from the time-series coordinates, and an operation history, which indicates that each stroke data has been deleted, may be added to the time-series information.

The ruled line setup module 307 sets the interval, kind, etc. of ruled liens which are displayed on an area on which a handwriting input can be executed. When a stroke has been input by handwriting by the user on a setup screen for setting ruled lines, when a stroke is being input by handwriting by the user on an area on which a handwriting input can be executed, or when setup (re-setup/update) of ruled lines has been instructed by the user, the ruled line setup module 307 sets the interval, kind, etc. of ruled lines by using stroke data included in the setup screen, in the handwriting input-capable area, or in a past handwritten document.

By using the stroke data corresponding to character strings of two rows (or two columns) or more, which have been input by handwriting by the user, the ruled line setup module 307 displays, on the handwriting input-capable area, rules lines at intervals which are determined in accordance with positions (areas) where the strokes are displayed. The ruled line setup module 307 displays ruled lines on the handwriting input-capable area with the kind of lines which is selected by the user, such as a solid line, a dotted line, a dot-and-dash line, or a wavy line. The ruled line setup module 307 may display ruled lines, such as horizontal lines or vertical lines, in accordance with the order (order of handwriting) of strokes which have been input by handwriting by the user, or may display ruled lines, namely horizontal lines, vertical lines, vertical-and-horizontal lines (grid lines) or lines of manuscript paper, in accordance with the user's operation. The user can set intervals of ruled lines by inputting, by handwriting, character strings of two rows (or two columns) or more on the setup screen for setting ruled lines or on the normal handwriting area. Ruled lines may be any lines if they are a plurality of lines which are displayed at regular intervals on the handwriting input-capable area. The ruled lines may be displayed at identical intervals in the whole file or page, may be displayed at intervals which are different between a plurality of areas included in a page, or may be displayed on only a part of a page. The user can set up the display mode/layout of ruled lines on the setup screen. For example, the user can execute setup as to in which of areas of a page the ruled lines are to be displayed, and setup as to the arrangement, etc. of plural areas on which ruled lines with different intervals are to be displayed. The ruled lines may, or may not be, capable of being subjected to a select process, an edit process, etc. The ruled lines may be stored in a format which is different from the format of stroke data, or may be stored in the same format.

The recognition process module 309 executes a block-structuring process of characters and rows (or columns) by using the stroke data corresponding to character strings of two rows (or two columns) or more for setting intervals of ruled lines which are to be displayed on the handwriting input-capable area. The block-structuring process may be any process if it can divide a plurality of strokes corresponding to stroke data into a block (group) in units of a character, a row or a column.

In a block-structuring process on a character by character basis, for example, a circumscribed rectangle of each stroke is generated and strokes, whose circumscribed rectangles overlap at least partly, may be set in the same block, or strokes, the degree of overlap of which exceeds a threshold, may be set in the same block. In the block-structuring process on a character by character basis, for example, strokes, whose coordinates overlap at least at one point of coordinates constituting each stroke, may be set in the same block, or strokes, the degree of overlap of which exceeds a threshold, may be set in the same block. Furthermore, in executing the block-structuring process on a character by character basis, these methods may be used in combination.

A block-structuring process on a row (column) by row (column) basis may be any process if it can specify a stroke group corresponding to a character string of one row (one column) and can form a block (group) in units of a row (column). In the block-structuring process on a row (column) by row (column) basis, for example, areas in which character-unit blocks are displayed or areas of circumscribed rectangles, and the order (handwriting order) of stroke data corresponding to the character-unit blocks may be used, and furthermore a distance between the character-unit blocks may be used.

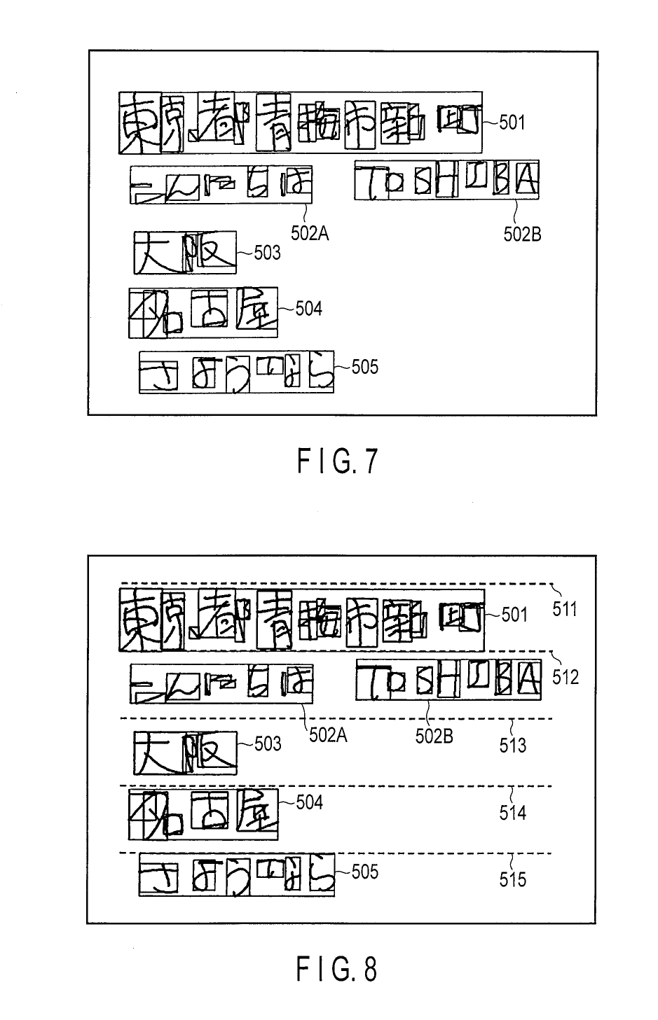

FIG. 7 illustrates an example of a result of a block-structuring process of a plurality of strokes. FIG. 7 shows that a circumscribed rectangle is set for one or more strokes which were input by handwriting, and a block is formed in units of a character or a row, based on the unit by which the circumscribed rectangle was set. Incidentally, one or more strokes, which are set in one block (of any one of a character, a row or a column), are surrounded by one circumscribed rectangle. FIG. 7 shows that a plurality of areas (display areas) 501, 502A, 502B, 503, 504 and 505 were defined by the block-structuring process.

Using the result of the block-structuring process by the recognition process module 309, the interval determination module 310 determines the intervals of ruled lines which are displayed on a handwriting input-capable area. The interval determination module 310 determines the intervals of ruled lines by using a first area which displays a block (first stroke group) corresponding to a first row (or column), . . . , an n-th area which displays a block (n-th stroke group) corresponding to an n-th (n: an integer of 2 or more) row (or column). The first area through the n-th area may be defined in any manner if the first through n-th stroke groups are included in these areas.

For example, when n is 2, the interval determination module 310 determines the intervals of ruled lines by using the sizes (character sizes) of the first area and second area and the size (margin size) of an area between the first area and second area. The interval determination module 310 may determine the interval of ruled lines to be a value which is obtained by adding an average value of the sizes of the first and second areas and the size of the area between the first area and second area.

For example, when n is 3, the interval determination module 310 determines the intervals of ruled lines by using the sizes (character sizes) of the first area to third areas, the size of an area between the first area and second area and the size (margin size) of an area between the second area and third area. The interval determination module 310 may determine the interval of ruled lines to be a value which is obtained by adding an average value of the sizes of the first to third areas and an average value of the size of the area between the first area and second area and the size of the area between the second area and third area. When n is 4 or more, the interval determination module 310 may similarly determine the intervals of ruled lines.

The interval determination module 310 can determine the intervals of vertical-and-horizontal lines (grid lines) or ruled lines of manuscript paper, by using the results of the block-structuring process on a character by character basis, the block-structuring process on a row by row basis and the block-structuring process on a column by column basis. The interval determination module 310 can determine the intervals of vertical-and-horizontal lines (grid lines) or ruled lines of manuscript paper, by using only the result of the block-structuring process on a character by character basis.

FIG. 8 illustrates an example of the process result of setup of the intervals of ruled lines, with use of the stroke data in the example of FIG. 7. FIG. 8 illustrates an example in which ruled lines were displayed for the display areas 501, 502A, 502B, 503, 504 and 505 of strokes which were input by handwriting for setting ruled lines. However, ruled lines may be displayed for only a handwriting input-capable area which is different from the display area (e.g. setup screen) of strokes which were input by handwriting for setting ruled lines. FIG. 8 shows that ruled lines 511, 512, 513, 514 and 515 were set for areas which display a row of the display area 501, a row of the display areas 502A and 502B, a row of the display area 503, a row of the display area 504, and a row of the display area 505.

In the first embodiment, as described above, the ruled lines, which correspond to the kind of ruled line that is set by the ruled line determination module 307 and the intervals of ruled lines that are set by the interval determination module 310, are displayed on the screen of the touch-screen display 17. By the user inputting character strings of two rows (or columns) or more by handwriting, the ruled lines at intervals, which are suited to a handwriting input on the screen of the touch-screen display 17, can be displayed.

As regards ruled lines on a handwriting input-capable area on, for example, the tablet 10 which enables a direct handwriting input on the screen of the touch-screen display 17, such a scheme is thinkable that the user is prompted to set the interval of ruled lines by points or millimeters, and to judge, by preview or the like, whether the interval is suited to a handwriting input for the user. However, it is difficult to say that such a method of setting the interval of ruled lines is intuitive for the user, and it is unclear whether the setting method is suited to a handwriting input for the user. As a result, there occurs a problem that re-setup becomes necessary and the procedure of setup becomes troublesome. In the first embodiment, since the user can set ruled lines by inputting character strings of two rows (or columns) or more by handwriting, the convenience for the user is high. In addition, since ruled lines which are suited to the sense of each individual user can be generated, the user can execute an input by more conformable handwriting.

In the above-described example, the description has been given of the case of the mode in which the user inputs character strings of two rows (or columns) or more by handwriting on the setup screen for setting ruled lines or on the normal handwriting area. However, in order to set ruled lines, it is not necessary for the user to separately input character strings by handwriting. For example, ruled lines may be set by using electronic data of handwritten documents which were input in the past by the user and stored in the tablet 10, personal computer 1 or server 2. By selecting which handwritten document is to be used to set ruled lines, the user can display ruled lines at intervals which are suited to a handwriting input on the screen of the touch-screen display 17.

In the above description, the digital notebook application program 202 and the respective functional blocks are executed by the CPU 101, but the embodiment is not limited to this example. The ruled line setup module 307 (recognition process module 309, interval determination module 310) may be realized by being executed by the processor in the personal computer 1 or the processor of the server 2. In this case, the tablet 10 may send the stroke data for setting ruled lines to the personal computer 1 or server 2.

All the pen locus display process module 301, time-series information generation module 302, edit process module 303, page storage process module 304, page acquisition process module 305, handwritten document display process module 306 and ruled line setup module 307 (recognition process module 309, interval determination module 310) may be realized by being executed by the processor in the personal computer 1 or the processor of the server 2. In this case, the tablet 10 may send the information of, e.g. events detected by the touch-screen display 17, and the information of, e.g. operations of the edit menu by the user, to the personal computer 1 or server 2, and may receive image information indicative of a final processing result.

The functional blocks of the digital notebook application program 202, excluding the time-series information generation module 302 and handwritten document display process module 306, may be realized by being executed by the processor in the personal computer 1 or the processor of the server 2. In this case, the tablet 10 may send the time-series information that is input by the user, and the information of, e.g. operations of the edit menu, to the personal computer 1 or server 2.

When at least one functional block of the digital notebook application program 202 is realized by being executed by the processor in the personal computer 1 or the processor of the server 2, as described above, the working memory 401 and storage medium 402 are realized by at least one storage of the storage device in the tablet 10, the storage device in the personal computer 1 and the storage device of the server 2.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
an input terminal configured to input first stroke data corresponding to a plurality of strokes described by handwriting and second stroke data corresponding to a plurality of second strokes described by handwriting; and
a display controller configured to execute control to display an n-number (n: an integer of 2 or more) of first lines at first intervals determined in accordance with a first area including the plurality of first strokes and a second area including the plurality of second strokes.

2. The electronic device of claim 1, wherein the display controller is configured to execute control to display a setup screen for determining the first intervals, and
the plurality of first strokes and the plurality of second strokes are input on the setup screen.

3. The electronic device of claim 2, wherein the display controller is configured to execute control to display the n-number of first lines on a first screen different from the setup screen, in accordance with the first intervals determined on the setup screen.

4. The electronic device of claim 1, wherein the plurality of first strokes correspond to a first row or column of a character string, and
the plurality of second strokes correspond to a second row or column of a character string.

5. The electronic device of claim 1, wherein the plurality of first strokes correspond to a first character, and
the plurality of second strokes correspond to a second character.

6. The electronic device of claim 1, further comprising a touch-screen display,
wherein the first stroke data and the second stroke data are input through the touch-screen display, and
the n-number of first lines are displayed on a screen of the touch-screen display.

7. A method which is executed by using a computer which is connectable to a display, the method comprising:
inputting first stroke data corresponding to a plurality of strokes described by handwriting and second stroke data corresponding to a plurality of second strokes described by handwriting; and
executing control to display an n-number (n: an integer of 2 or more) of first lines at first intervals determined in accordance with a first area including the plurality of first strokes and a second area including the plurality of second strokes.

8. A computer-readable, non-transitory storage medium having stored thereon a program which is executable by a computer which is connectable to a display, the program controlling the computer to execute functions of:
inputting first stroke data corresponding to a plurality of strokes described by handwriting and second stroke data corresponding to a plurality of second strokes described by handwriting; and
executing control to display an n-number (n: an integer of 2 or more) of first lines at first intervals determined in accordance with a first area including the plurality of first strokes and a second area including the plurality of second strokes.
